(19) United States
(12) Patent Application Publication
(10) Pub. No.: US 2024/0079994 A1
(43) Pub. Date: Mar. 7, 2024

(54) POWER GENERATING APPARATUS

(71) Applicant: MAKINEX IP PTY LTD, Sydney (AU)

(72) Inventor: Rory Campbell KENNARD, Sydney (AU)

(73) Assignee: MAKINEX IP PTY LTD, Sydney (AU)

(21) Appl. No.: 18/262,688

(22) PCT Filed: Jan. 18, 2022
(86) PCT No.: PCT/AU2022/050021

§ 371 Date: Jul. 24, 2023

(30) Foreign Application Priority Data
Jan. 22, 2021 (AU) 2021900137

(51) Int. Cl. H02S 30/20; H02S 10/40

(52) U.S. Cl. CPC H02S 30/20; H02S 10/40

(57) ABSTRACT

A portable power generating apparatus (210), including an array (228) of solar panels (220 to 227) which are configured to adopt a stowed position (FIG. 17), and, an operative position (FIG. 21). The apparatus (210) includes a main structure (212), and a plurality of solar panels (220 to 227). In the stowed position (FIG. 17), the solar panels (220 to 227) are compactly stored and are substantially located within an extremity (215) of abase (214) of the apparatus (210). In the operative position (FIG. 21), the panels (220 to 227) are arranged in the form of an array (228) of substantially upwardly facing panels. The solar panels (220 to 227) are attached the main structure (212) of the apparatus (210) to frames via sliding track mechanisms (260) and/or hinge mechanisms (262) for movement of the panels (220 to 227) between the stowed (FIG. 17) and operative position (FIG. 21).

### TECHNICAL FIELD

This disclosure relates generally to electric power generator systems and more particularly to portable, standalone solar power generating system.

### BACKGROUND ART

Electric power is often required in circumstances where grid power is unavailable or unusable. This often occurs at remote sites such as mining or telecommunication utilities. Currently motor powered electric generators such as diesel or gas generators are generally used in such circumstances. Generators of this type suffer from several disadvantages including excessive noise and emissions issues, relative high maintenance and servicing costs as well as high fuel costs.

### SUMMARY DISCLOSURE

In a broad form, the present invention relates to a portable power generating apparatus, including: a main structure, including a base adapted to be positioned on a substrate surface; and, a plurality of solar panels, operatively mounted to the main structure, and configured to adopt: a stowed position in which the panels are substantially compactly stored within or adjacent to an extremity of said base; and, an operative position, in which the panels are arranged in the form of an array of substantially upwardly facing panels.

Preferably, the main structure includes: an inboard section disposed substantially above said base, and, a pair of side sections, each side section including: a side frame which is operatively connected and pivotally movable relative to a respective side of the inboard section, to support a side group of said plurality of solar panels.

Preferably, the portable power generating apparatus includes an actuator to effect the pivotal movement of each side frame and its respective side group of said solar panels relative to said inboard section.

Preferably, each side frame is configured to move at least two panels which form said side group between: a stowed position wherein said panels substantially overlap; and, an operative position wherein said panels are substantially side by side.

Preferably, each side frame includes a sliding track mechanism configured to effect sliding movement of at least two panels of said side group relative to each other.

Preferably, each side frame includes a hinge mechanism configured to effect pivotal movement of at least two panels of said side group relative to each other.

Preferably, each side frame includes both a sliding track mechanism and a hinge mechanism configured to effect both sliding and/or pivotal movement of some of said side group panels relative to each other.

Preferably, said solar panels are configured to be angularly adjustable so as to orient the panels towards the sun.

Preferably, the portable power generating apparatus includes a solar tracking system configured to automatically control the orientation of the solar panels.

Preferably, the base of the main structure includes tyne receiving zones, each adapted to receive a tyne of a fork lift.

Preferably, the base of the main structure further includes a plurality of stabilising legs configured to extend substantially outwardly from said base to contact the substrate surface.

Preferably, the portable power generating apparatus further includes an energy storage system which is electrically connected to said panels.

Preferably, the portable power generating apparatus further includes a power inverter.

Preferably, the portable power generating apparatus further includes a backup generator, including a diesel or other fuel powered generator or an electric generator.

In a further broad form, the present invention relates to a portable power generating apparatus, including: a main structure, including: a base, having: a pair of tyne receiving zones, adapted to receive tynes of a fork lift; a plurality of stabilising legs configured to extend substantially outwards of said base to contact a substrate surface; an inboard section, disposed above said base; a pair of side sections, each side section including a side frame which is operatively connected to and pivotally movable relative to a respective side of the inboard section; a plurality of solar panels operatively mounted to the main structure, configured to adopt: a stowed position in which the panels are substantially located within or adjacent to an extremity of said base and said inboard section; and, an operative position, in which the panels are arranged in the form of an array of substantially upwardly facing panels.

In a further broad form, the present invention relates to a method of supplying portable power, including the steps of: transporting the portable power generating apparatus, as described hereinabove, whilst the apparatus is in the stowed position; rearranging the position of the solar panels, from the stowed position to the operative position, such that the panels are arranged in the form of the array of substantially upwardly facing panels.

### BRIEF DESCRIPTION OF THE DRAWINGS

Notwithstanding any other forms which may fall within the scope of the method and apparatus set forth in the summary, specific embodiments of the method and apparatus will now be described by the way of example and with reference to the accompanying drawing in which:

FIG. 1 is a schematic isometric view of an apparatus according to one embodiment viewed from an upper side when in an operative position;

FIG. 2 is a schematic isometric view of the apparatus shown in FIG. 1 viewed from an underside;

FIGS. 3A, 3B and 3C are details of various parts of the apparatus shown in FIG. 2;

FIG. 4 is a side elevation of the apparatus shown in FIGS. 1 to 3;

FIG. 5 is a schematic isometric view of the apparatus shown in FIGS. 1 to 4 when in a stowed position;

FIGS. 6 to 10 illustrate the various stages for taking the apparatus from the stowed position to the operative position;

FIG. 11 is a schematic isometric view of apparatus according to a further embodiment when in an operative position;

FIG. 12 is a schematic isometric view of the apparatus shown in FIG. 11 when in a stowed position;

FIGS. 13 to 16 illustrate the various stages for taking the apparatus shown in FIG. 12 from the stowed position to the operative position;

FIG. 17 is a schematic isometric view of an apparatus according to a further embodiment viewed from an upper side when in a stowed position; and

FIGS. 18 to 21 illustrate the various stages for taking the apparatus shown in FIG. 17 from the stowed position to the operative position.

### DETAILED DESCRIPTION

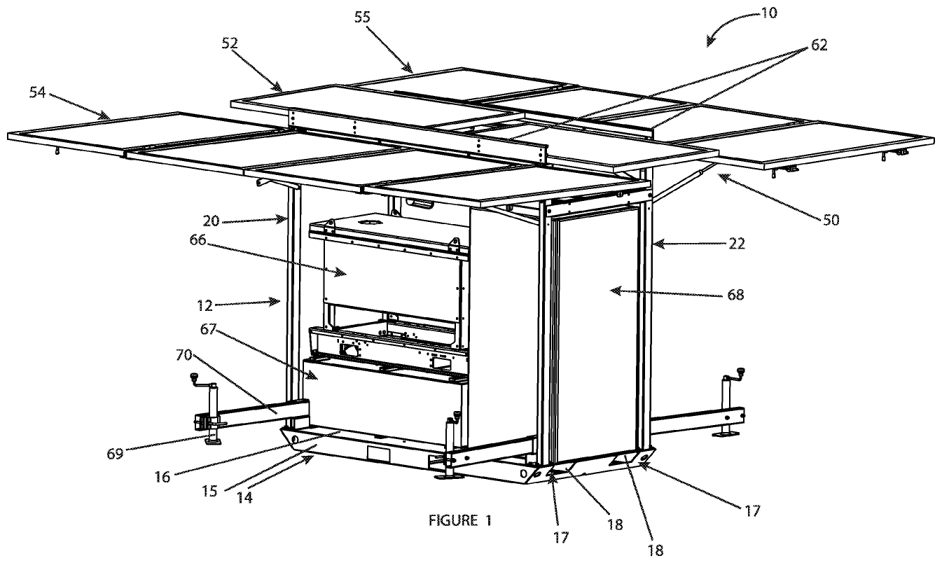

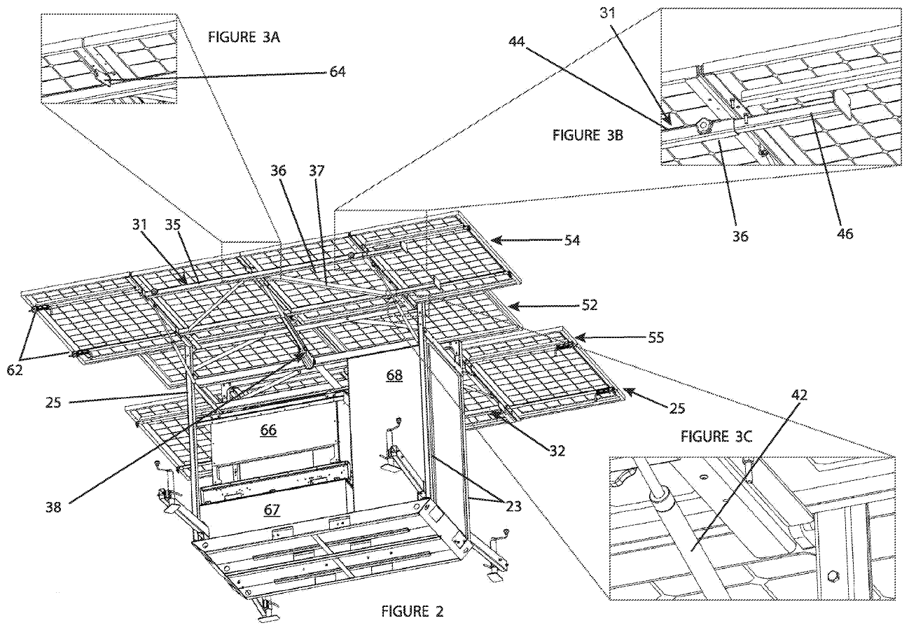

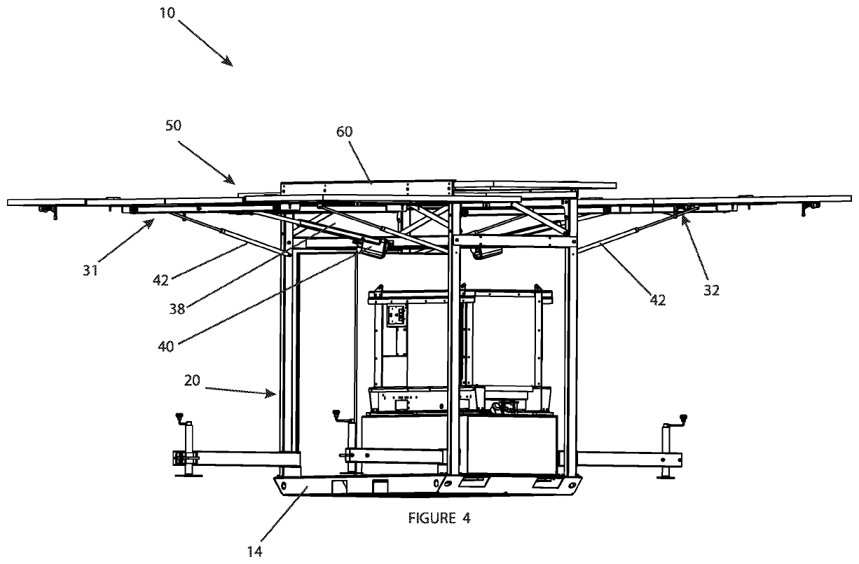

Referring to FIGS. 1 to 10, there is illustrated a power generating apparatus, generally indicated as 10, which comprises a main structure 12 which includes a base 14, and an inboard section 20, extending upwardly from the base 14. The base 14 comprises a base body 15 which is generally rectangular in shape when viewed in plan and has an upper platform surface 16 for carrying other components of the apparatus. The base 14 includes tyne receiving zones 17 in the form of passages 18 extending inwardly from one side of the base 14. The passages 18 are adapted to receive the tynes or forks of a forklift vehicle so as to enable the apparatus to be lifted and moved.

The inboard section 20 of the main structure 12 is in the form of a frame which include uprights 23 extending upwardly from corners of the base 14 and cross members 25 towards upper ends of the uprights 23 and extending therebetween so as to form a rigid structure.

The main structure 12 further includes two side sections 31 and 32 which are operatively connected to the inboard section 20. The side sections 31 and 32 are on opposite sides of the inboard section 20 and moveable relative thereto between a raised or extended position when the apparatus is in an operative position, and, a lowered or retracted position when the apparatus is in a stowed position. The side sections 31 and 32 are mounted for pivotal movement between the raised and lowered positions. To this end the side sections 31 and 32 each comprise a frame 35 hingedly connected to the inboard section 20 to effect the pivotal movement. The side sections 31 and 32 include support arms 36 and 37, the purpose of which will become hereinafter apparent.

As shown in detail in FIG. 3B, the support arms 36 and 37 include a main section 44 and two end sections 45 and 46, which are moveable relative to the main section between extended and retracted positions. An actuator 38 is operable to cause movement of the side sections 31 and 32 between the extended and retracted positions. The actuator 38 can be arranged to position the side sections 31 and 32 in any position between the fully retracted and fully extended positions. Thus, the side sections 31 and 32 can be arranged in an inclined fashion. The side sections can therefore adopt any one of a number of operative positions. The actuator 38 may be in the form of a hydraulic piston/cylinder assembly 39 powered by hydraulic motor 40. The side sections 31 and 32 are also supported by struts 42 which, in the form shown, are gas struts, when the side sections are in any one of the extended position.

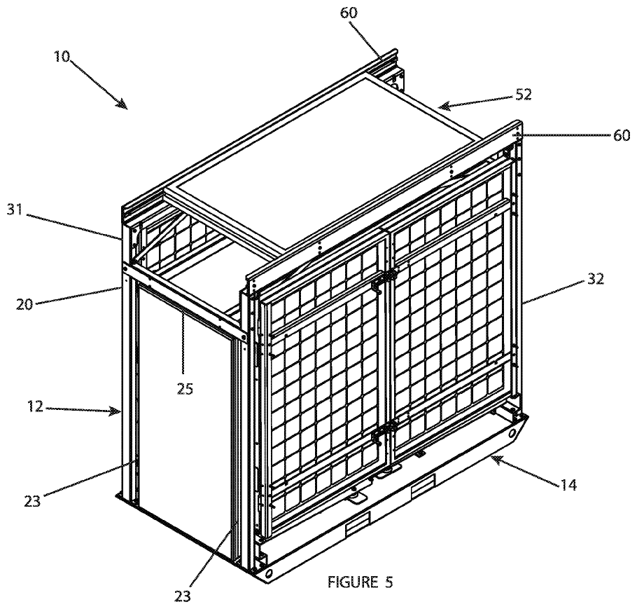

The apparatus 10 further includes a solar powered generator system 50, which comprises a series of solar panels which are in the form of photovoltaic panels 81-97 (FIG. 10) operatively mounted to the main structure 12. The panels are substantially planar or flat in shape and rectangular or square when viewed in plan. The system 50 comprises three groups of solar panels and includes a central group 52 and two side groups 54 and 55. The central group, in the embodiment shown, comprises two solar panels 81 and 82. The side groups 54 and 55, in the embodiment shown, each comprise four solar panels 84, 85, 86 and 87, and 94, 95, 96 and 97 respectively, As best seen in FIGS. 1, 9 and 10, when in the operative position, the solar panels in the three groups are arranged in an array with the solar collecting side of the panels facing upwardly. As shown in FIG. 5, the solar panels in the three groups are configured so as to be able to adopt the stowed position in which they are, in essence, located within or adjacent to the boundary of the base 14 and the inboard section 20 of the main structure 12.

As shown, the two panels 81 and 82 which form the central group 52 are moveable relative to one another so that in the operative position they are arranged side by side, and, in the stowed position, they are arranged one on top of the other. To this end the panels 81 and 82 are mounted on or in tracks or rails 60 on the inboard section 20 for slidable movement therealong. FIGS. 5 to 9 show the panels in the stowed position and FIGS. 1 to 3 and 10 and 11 show the panels in the operative position.

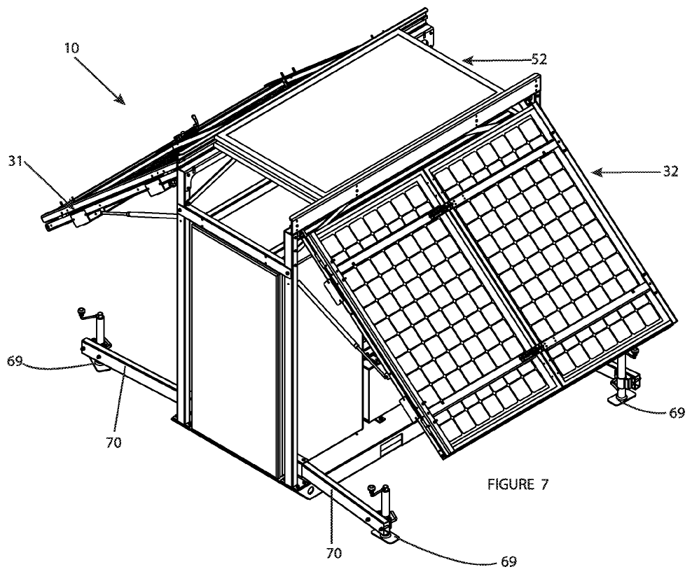

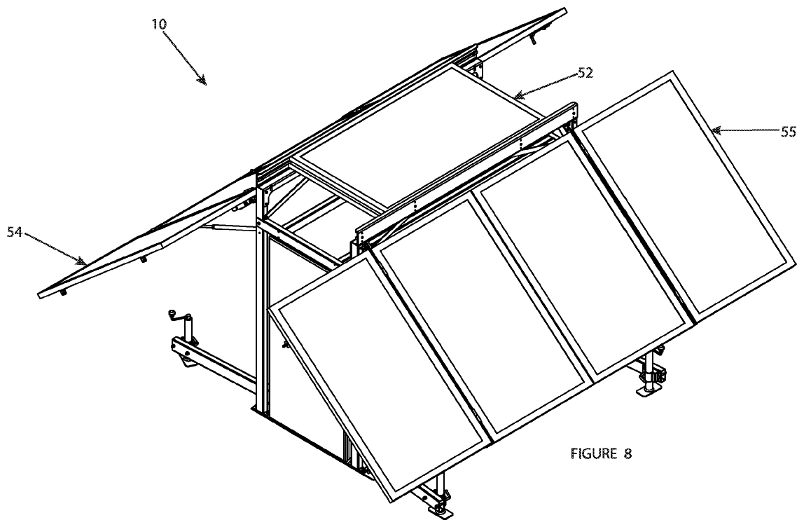

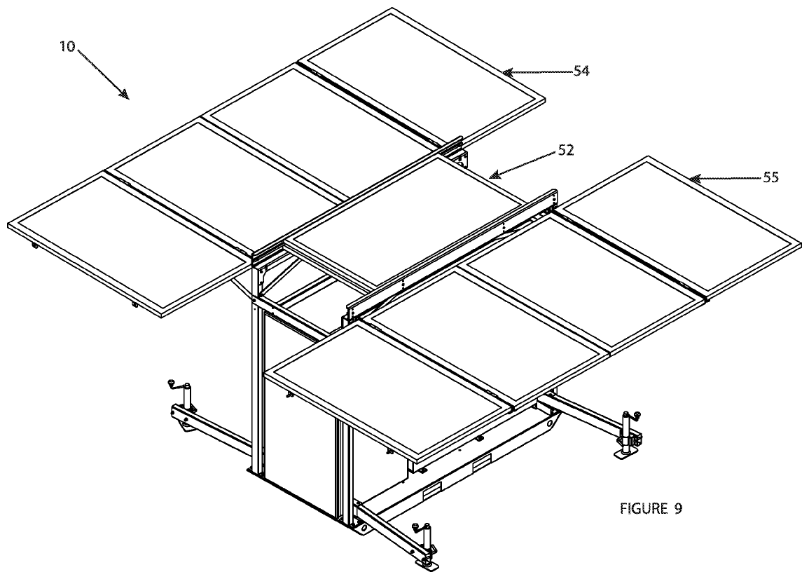

The two side groups of panels 54 and 55 are disposed on opposite sides of the central group 52. When in the operative position, the panels forming the side groups 54 and 55 extend away from the central group 52. The panels 84, 85, 86, 87 and 94, 95, 96, 97 in each side group 54 and 55 are arranged side by side, when in the operative position. In this position, the panels in each group are supported by support arms 36 and 37 together with the actuator 38 and struts 42. In this position, the end sections 45 and 46 of the support arms 36 and 37 are fully extended with respect to the main section 44 so that the outermost panels 84, 87 and 94, 97 of the two groups are properly supported. One side of each of the outermost panels is hingedly connected to an inner adjacent panel; that is panel 84 is hingedly connected to panel 85, panel 87 is hingedly connected to panel 86, panel 94 is hingedly connected to panel 95 and panel 97 is hingedly connected to panel 96. The arrangement is such that the outermost panels can be folded over so as to be disposed on top of an adjacent innermost panel in a folded position. This is clearly illustrated in FIG. 7. A locking arrangement is operable to hold the panels in the folded position. The locking arrangement may include lock bolts 62 which cooperative with a tab 64 to hold the panels in the folded position. The tab 64 is rotatable from a position below the panels when not required to a position above the panels to hold the panels in the folded position.

As shown in FIG. 5, when in the stowed position, the side sections 31 and 32 are disposed along opposite sides of the inboard section 20. In this position, the groups of panels 54 and 55, carried by the side sections 31 and 32, are disposed in upright planes adjacent to the sides of the inboard section.

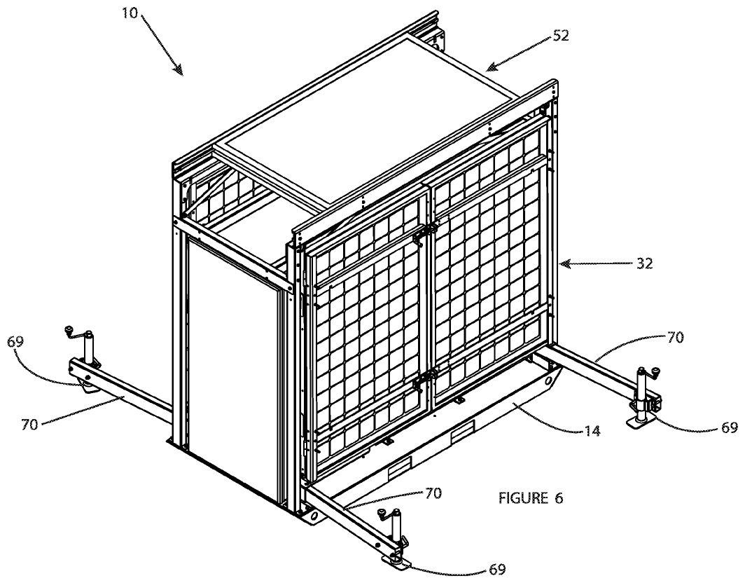

The first step in moving the apparatus into the operative position is to swing the arms 70 into a position in which they extend outwardly away from the inboard section 20. The legs 69 can then be attached to the arms 70 so as to provide a stable support for the apparatus. This is shown in FIG. 6.

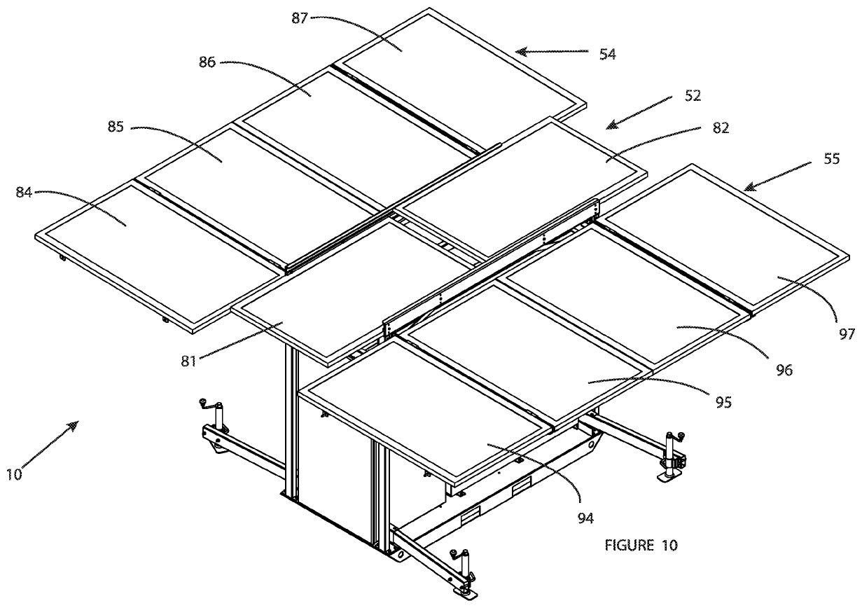

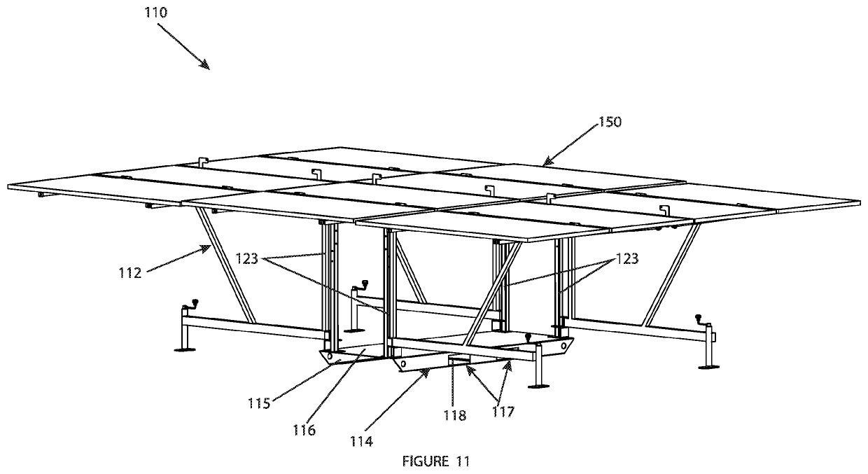

As shown in FIG. 7, the actuators 38 are activated to pivotally move the side sections 31 and 32 away from the inboard section 20. As shown in FIG. 8, the panels in the panel groups 54 and 55 are unfolded so that the panels in each group are arranged side by side. The side sections 31 and 32 are then moved to the position shown in FIG. 9. Finally, as shown in FIG. 10, the two panels 81 and 82, forming the panel group 52, are moved along tracks 60 so as to be positioned side by side.

The apparatus 10 further includes an energy storage system 66 disposed above the base 14. The photovoltaic panels are electrically connectable to the energy storage system 66 which is configured to store electrical energy generated by photovoltaic panels. The energy storage system 66 may comprise one or more rechargeable electric batteries. In some examples, the energy storage system 66 comprises a battery bank comprising two or more interconnected electric batteries. The energy storage system 66 may further comprise a battery controller or charge regulator electrically connected between photovoltaic panels and electric batteries for controlling the rate at which electrical energy from photovoltaic panels is added to electric batteries.

A power inverter 67 is provided for conditioning the electrical power generated by the photovoltaic panels for supply to an electrical load electrically connected to power inverter. The power inverter 67 may be configured to convert DC power generated by photovoltaic panels 110 to AC power suitable for supply to an electrical load. The power inverter 67 may be electrically connected to energy storage system and/or to the photovoltaic panels.

The apparatus 10 further includes a backup electrical generator 68 for supplying electrical power to a load when the power generated by photovoltaic panels or the power stored in energy storage system 67 is insufficient for powering a load. The generator 68 may comprise any type of electrical generator, including a diesel generator. The generator 68 may be electrically connected to one or more input ports of power inverter 67.

A solar tracking system may be provided for orienting the photovoltaic panels towards the sun. The solar tracking system may be configured to control an orientation of a photovoltaic panel to reduce or minimise an angle of incidence between the photovoltaic panel and light from the sun. The solar tracking system may control the orientation of a photovoltaic panel along one axis (e.g east-west) or along multiple axes (e.g. east-west and north south). In some examples, the solar tracking system comprises mechanical actuators for automatically controlling the orientation of the photovoltaic panels. In other examples, the solar tracking system comprises a mechanism for manually controlling the orientation of the photovoltaic panels.

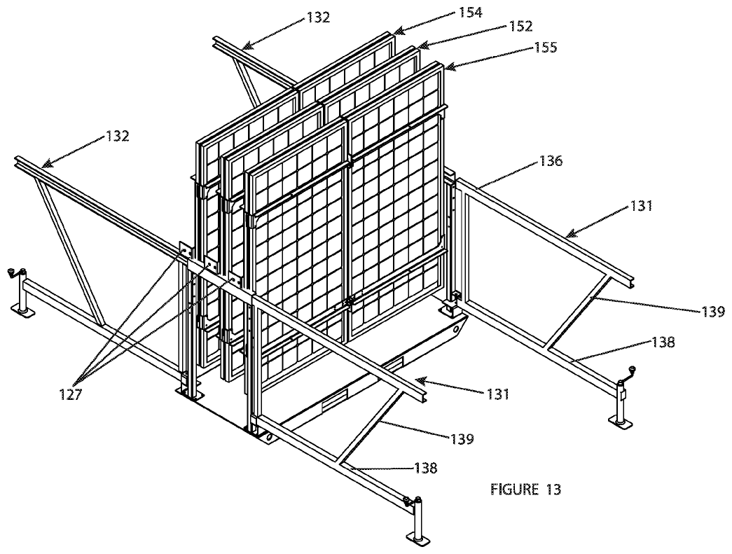

A further embodiment is described with reference to FIGS. 11 to 16. Referring to FIGS. 11 to 16, there is illustrated a power generating apparatus, generally indicated at 110, which comprises a main structure 112 which includes a base 114, and an inboard section 120, extending upwardly from the base 114. The base 114 comprises a base body 115 which is generally rectangular when viewed in plan and has an upper platform surface 116 for carrying other components of the apparatus. The base 114 includes tyne receiving zones 117 in the form of passages 118 extending inwardly from one side of the base 114. The passages 118 are adapted to receive the tynes or forks of a forklift vehicle so as to enable the apparatus to be lifted and moved.

The inboard section 120 of the main structure 112 is in the form of a framework comprising two parts on opposite sides of the base, each part including uprights 123 extending upwardly from corners of the base 114 and a cross member 125 towards upper ends of the uprights 123 and extending therebetween. The cross members 125 of the two parts are parallel to one another and form part of a track or rail.

The main structure 112 further includes two side sections 131 and 132 which are operatively connected to the inboard section. The side sections 131 and 132 each comprise two frame assemblies and each frame assembly is pivotally mounted to a respective upright 123 on one side for pivotal movement between a support position and a withdrawn position. In the withdrawn position the frame sections are disposed adjacent the inboard section 120 and in the support position they extend away from the inboard section. Each frame assembly includes an upper support arm 136, which in the support position is axially aligned with one of the cross members 125. The cross members 125 and upper arms 136 together provide for two tracks or rails the purpose of which will hereinafter become apparent. Each frame assembly further includes a mounting member 137 which is hingedly connected to one of the uprights 123, a lower member 138 spaced from the upper support arm 136 and a strut 139 extending between the upper arm and lower member. Stabilizing legs 169 may be connected to outer ends of the lower members 138.

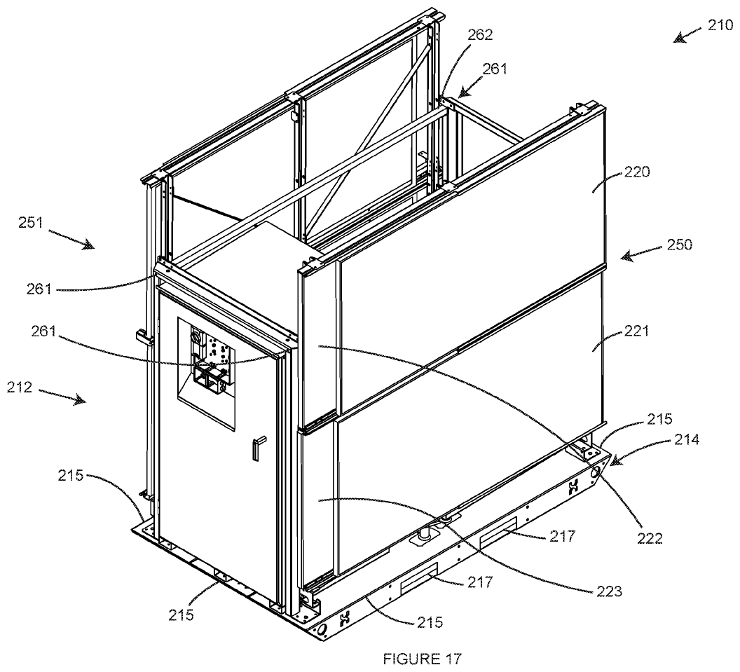

The apparatus 10 further includes a solar powered generator system 150 which comprises a series of solar panels which are in the form of photovoltaic panels operatively mounted to the main structure 12. The system 150 comprises three groups of solar panels and includes a central group 152 and two side groups 154 and 155. Each group in the embodiment shown comprises four solar panels 181,182,183 and 184. As best seen in FIG. 16, when in the operative position, the solar panels in the three groups are arranged in an array with the solar collecting side of the panels facing upwardly. As shown in FIG. 11 the solar panels in the three groups are configured so as to be able to adopt the stowed position, in which they are in essence located within the boundary of the base 114 and the inboard section 120 of the main structure 112.

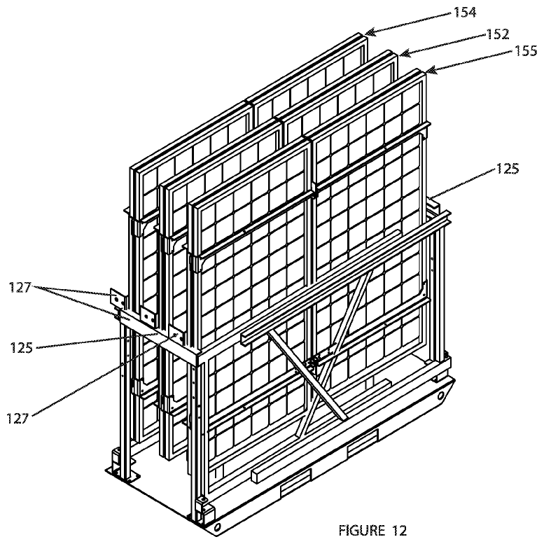

As shown in FIG. 16, when in the operative position, the panels 181, 182, 183 and 184 are arranged side by side and extend laterally with respect to the upper arms 136 the sides of the panels in one group are parallel to and adjacent to the sides of the panels in an adjacent group. Each of the groups of panels are operatively mounted to the upper arms 136 so as to be movable from the stowed position, as shown in FIG. 12, to the operative position, as shown in FIG. 16. When in the stowed position, the outermost panels 181 and 184 are hingedly connected to the adjacent innermost panels 182 and 183 respectively so that the outermost panels can overlie the inner panels 182 and 183 respectively. This is shown in FIG. 12.

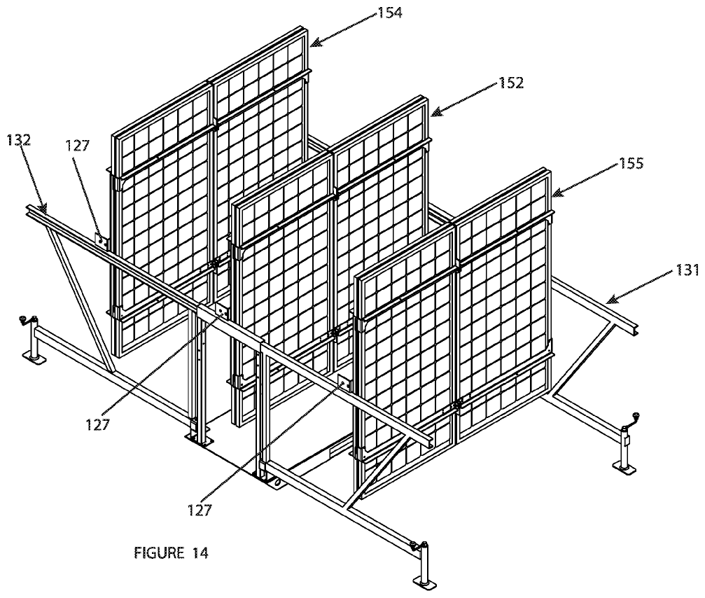

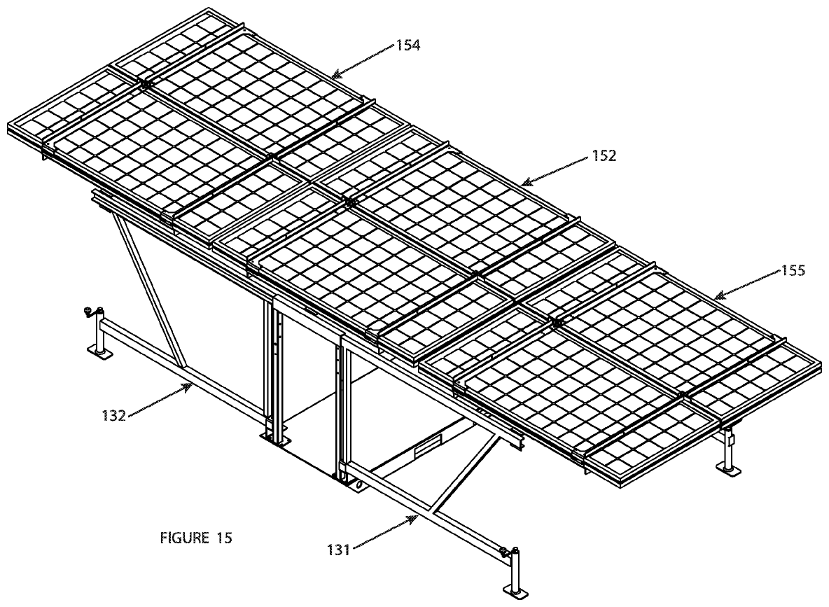

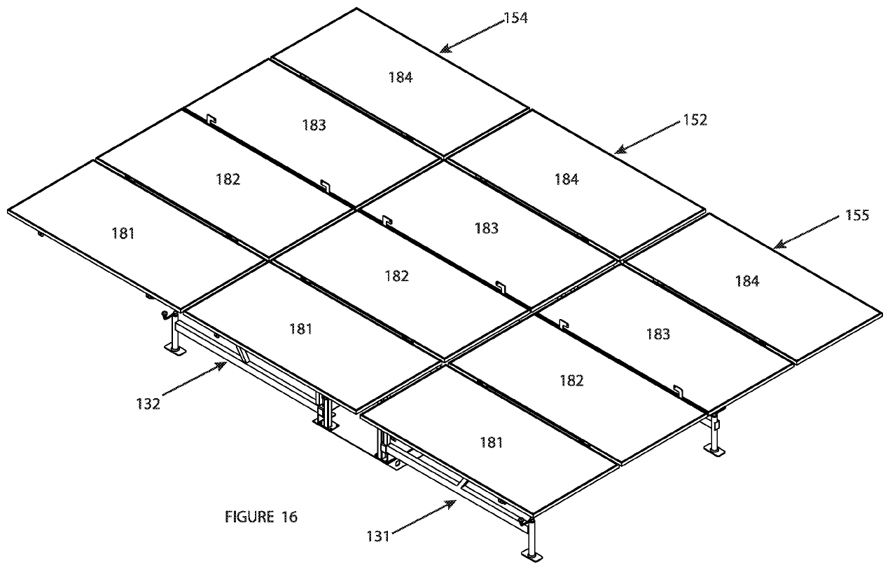

The groups of panels 152, 154 and 155 are operatively mounted by mountings 127 configured so that at least the outer groups 154 and 155 can be moved along across members 125 and arms 136. Thus, the groups can adopt a position shown in FIG. 14. The mountings 127 also facilitate that they can be disposed in a lateral or substantially horizontal plane, as shown in FIG. 15. The panels can then be folded outwardly so as to be in the operative position shown in FIG. 16.

Although not illustrated the apparatus of this embodiment can also include an energy storage system, a power inverted and backup generator as described with reference to the first embodiment. Alternatively, this apparatus can be connected to the apparatus of the first embodiment to provide additional solar power.

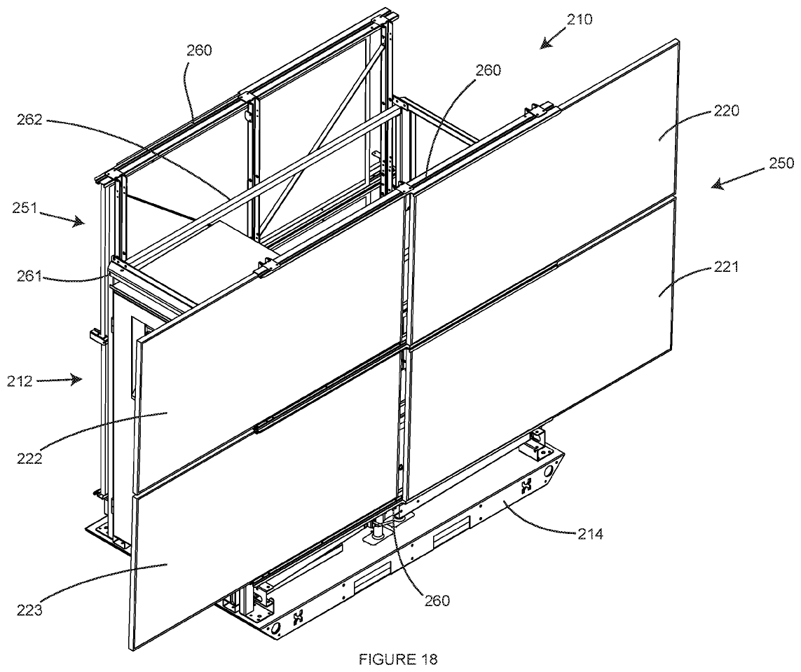

A further embodiment is described in FIGS. 17 to 21. Referring to FIGS. 17 to 21, there is described another embodiment of the power generating apparatus 210, somewhat similar to that of FIGS. 1 to 10, including a main structure 212, and a plurality of solar panels 220 to 227. In this case, the solar panels 220 to 223 form a first side group of solar panels 250, and the solar panels 224 to 227 form a second group of solar panels 251.

The main structure 212 of the apparatus 210 includes a base 214 which is adapted to be positioned on a substrate surface, and, an inboard section 213 which is disposed substantially above the base 214.

FIG. 17 illustrates the apparatus 210, wherein the solar panels 220 to 227 are compactly stored within or adjacent to the edges or extremity 215 of the base 214 of the apparatus 210, that is, showing the stowed position of the apparatus 210. FIG. 21 illustrates the apparatus 210, wherein one side group 250 of the solar panels 220 to 223 are arranged to be substantially upwardly facing so as to form of an array 228 of substantially upwardly facing panels, that is, showing the operative position of the apparatus 210.

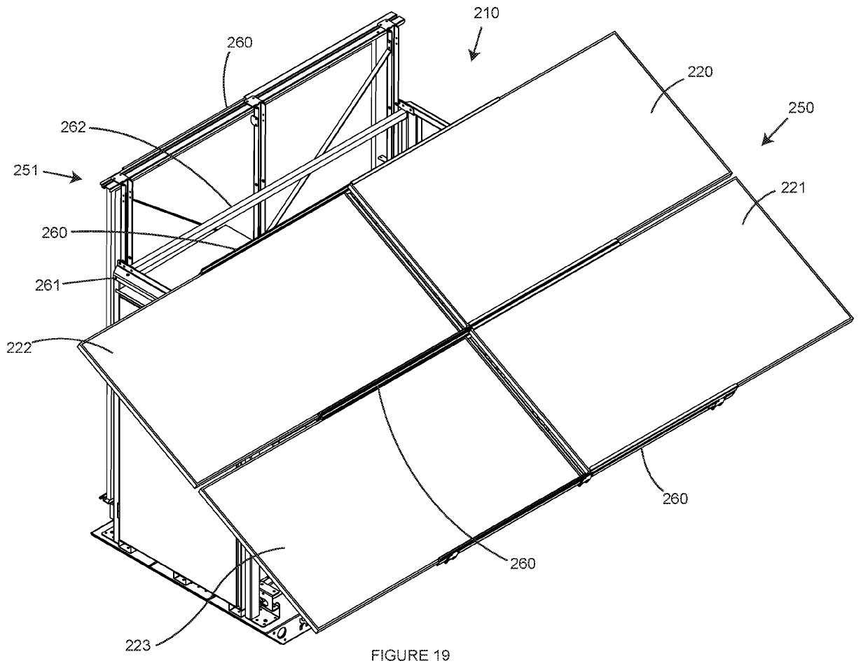

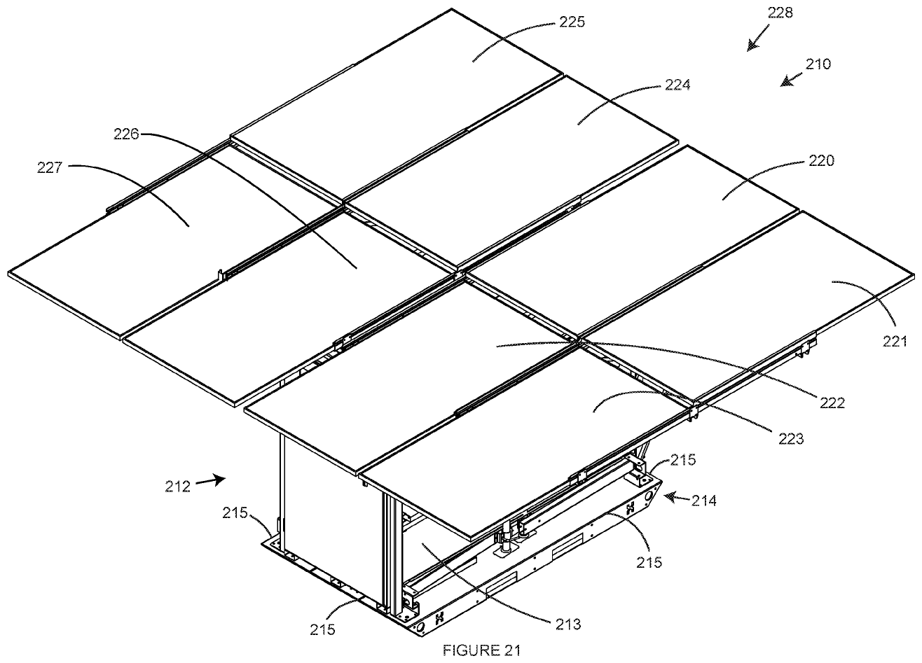

FIGS. 18, 19 and 20 show various intermediate positions of moving one side group 250 of solar panels of the apparatus 210, between the stowed position shown in FIG. 17, and, the operative position shown in FIG. 20.

In FIG. 18, it can be seen that in the side group of panels 250, the panels 220 and 221 are slid apart from the panels 222 and 223 so that they are moved from a position where they substantially overlap each other to a position where they are substantially side by side. This is effected by a sliding track mechanism 260.

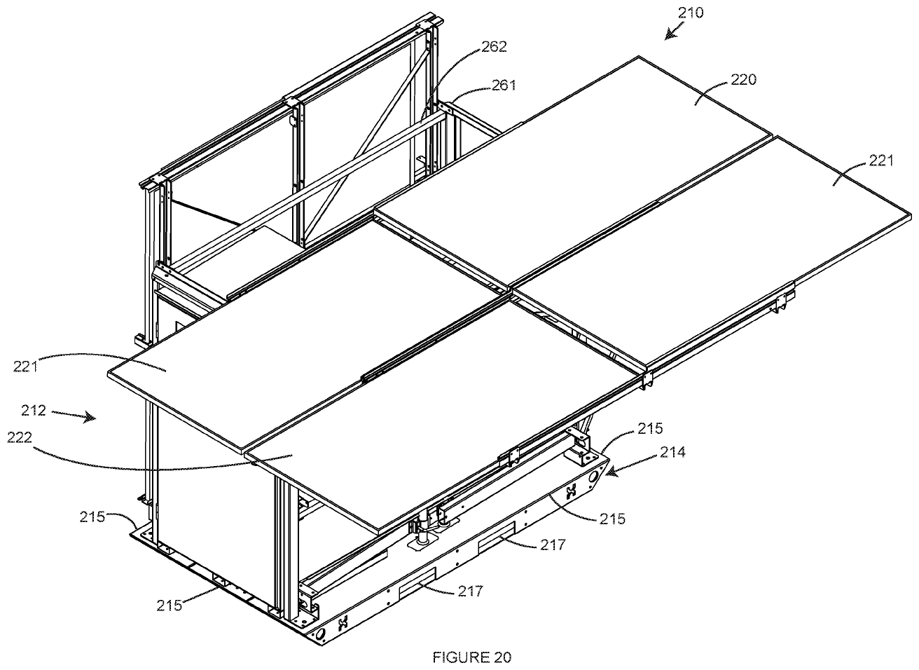

In FIG. 19, the group of side panels 250 has been pivotally moved via a hinge mechanism 262 about a pivot point 261, such that they are partially outwardly angled, whilst in FIG. 20, they have been further moved to be substantially upwardly facing. The group of side panels 251 on the opposite side of the inboard section 213 is similarly slidable and pivotally movable, so that the apparatus 210 then adopts the operative position as illustrated in FIG. 20.

The other side group of solar panels 251 is similarly moved, so that that all the solar panels 220 to 227 are positioned to form the array formation 228, as shown in FIG. 21.

The solar panels 220 to 227 are preferably ideally angled such that they are oriented to face towards the sun, so as to optimise their efficiency at generating solar electricity. This may be performed manually, or controlled automatically using an appropriate control system to maintain an optimal position to track the sun.

Various components, including a battery or other energy storage system to store the collected energy generated by the apparatus 210, and, an inverter to convert the energy to an AC power supply may be provided within the inboard section 213 of the apparatus 210. A backup power generator, such as a diesel generator, or a generator operating from another type of fuel source, and be additionally provided within the inboard section 213, so that in times of insufficient solar energy generation, the apparatus 210 may still be used to generate power.

The base 214 of the apparatus 210 may include tyne receiving zones 217, each of which is adapted to receive a tyne of a fork lift, for transportation and positioning of the apparatus 210.

Once positioned, and prior to the solar panels being moved from the stowed position to the operative position, stabilising legs may be operated to extend substantially outwardly and abut a substrate surface, so as to stabilise the apparatus 210.

In the forgoing description of preferred embodiments, specific terminology has been resorted to for the sake of clarity. However, the invention is not intended to be limited to specific terms so selected, and it is to be understood that each specific term includes all technical equivalents which operate in a similar manner to accomplish a similar technical purpose. Terms such as “front” and “rear”, “inner” and “outer”, “above”, “below”, “upper” and “lower” and the like are used as words of convenience to provide reference points and are not to be construed as limiting terms.

The reference in this specification to any prior publication (or information derived from it), or to any matter which is known, is not, and should not be taken as, an acknowledgement or admission or any form of suggestion that prior publication (or information derived from it) or known matter forms part of the common general knowledge in the field of endeavour to which this specification relates.

In this specification the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

In addition, the foregoing describes only some embodiments of the invention(s), and alterations, modifications, addition and/or changes can be made thereto without departing from the scope and spirit of the disclosed embodiments, the embodiments being illustrative and not restrictive.

Furthermore, invention(s) have been describe in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention(s). Also, the various embodiments described above may be implemented in conjunction with other embodiments, e.g. aspects of one embodiment may be combined with aspects of another embodiment to realise yet other embodiments. Further, each independent feature or component of any given assembly may constitute an additional embodiment.

The reference numerals in the following claims do not in any way limit the scope of the respective claims.

### TABLE OF PARTS

Apparatus 10
Main structure 12
Base 14
Base body 15
Upper surface 16
Tyne receiving 17
Passage 18
Inboard section 20
Frame work 22
Uprights 23
Cross members 25
Side sections 31, 32
Frame 35
Support arms 36,37
Actuator 38
Hydraulic piston/cylinder 39
Hydraulic motor 40
Struts 42
Main section 44
End sections 45, 46
Solar power generating system 50
Central panel group 52
Side panel groups 54, 55
Panels 81, 82, 84, 85, 86, 87, 94, 95, 96, 97
Tracks/rails 60
Lock bolts 62
Tab 64
Power storage system 66
Power inverter 67
Generator 68
Legs 69
Arms 70
Apparatus 110
Main structure 112
Base 114
Inboard section 120
Body 115
Platform surface 116
Tyne receiving zones 117
passages 118
Uprights 123
Cross members 125
Mountings 127
Side sections 131/132
Support arm 136
Mounting member 137
Lower member 138
Strut 139
Stabilizing leg 169
Solar power generating system 150
Central panel group 152
Side panel groups 154/155
Panels 181, 182, 183, 184
Apparatus 210
Main Structure 212
Inboard Section 213
Base 214
Edges 215
Panels 220, 221, 222, 223, 224, 225, 226, 227
Array Formation 228
Side Group Panels 250, 251
Sliding Track Mechanism 260
Pivot Point 261
Hinge Mechanism 262

1. A portable power generating apparatus, including:
a main structure, including a base adapted to be positioned on a substrate surface;
and,
a plurality of solar panels, operatively mounted to the main structure, and configured to adopt:
a stowed position in which the panels are substantially compactly stored within or adjacent to an extremity of said base; and,
an operative position, in which the panels are arranged in the form of an array of substantially upwardly facing panels.

2. The portable power generating apparatus as claimed in claim 1, wherein the main structure includes:
an inboard section disposed substantially above said base, and, a pair of side sections, each side section including:
a side frame which is operatively connected and pivotally movable relative to a respective side of the inboard section, to support a side group of said plurality of solar panels.

3. The portable power generating apparatus as claimed in claim 1, including an actuator to effect the pivotal movement of each side frame and its respective side group of said solar panels relative to said inboard section.

4. The portable power generating apparatus as claimed in claim 1, wherein each side frame is configured to move at least two panels which form said side group between:
a stowed position wherein said panels substantially overlap; and,
an operative position wherein said panels are substantially side by side.

5. The portable power generating apparatus as claimed in claim 1, wherein each side frame includes a sliding track mechanism configured to effect sliding movement of at least two panels of said side group relative to each other.

6. The portable power generating apparatus as claimed in claim 1, wherein each side frame includes a hinge mechanism configured to effect pivotal movement of at least two panels of said side group relative to each other.

7. The portable power generating apparatus as claimed in claim 1, wherein each side frame includes both a sliding track mechanism and a hinge mechanism configured to effect both sliding and/or pivotal movement of some of said side group panels relative to each other.

8. The portable power generating apparatus as claimed in claim 1, wherein said solar panels are configured to be angularly adjustable so as to orient the panels towards the sun.

9. The portable power generating apparatus as claimed in claim 1, including a solar tracking system configured to automatically control the orientation of the solar panels.

10. The portable power generating apparatus as claimed in claim 1, wherein the base of the main structure includes tyne receiving zones, each adapted to receive a tyne of a fork lift.

11. The portable power generating apparatus as claimed in claim 1, wherein the base of the main structure further includes a plurality of stabilising legs configured to extend substantially outwardly from said base to contact the substrate surface.

12. The portable power generating apparatus as claimed in claim 1, further including an energy storage system which is electrically connected to said panels.

13. The portable power generating apparatus as claimed in claim 1, further including a power inverter.

14. The portable power generating apparatus as claimed in claim 1, further including a backup generator, including a diesel or other fuel powered generator or an electric generator.

15. A portable power generating apparatus, including:
a main structure, including:
a base, having:
a pair of tyne receiving zones, adapted to receive tynes of a fork lift;
a plurality of stabilising legs configured to extend substantially outwards of said base to contact a substrate surface;
an inboard section, disposed above said base;
a pair of side sections, each side section including a side frame which is operatively connected to and pivotally movable relative to a respective side of the inboard section;
a plurality of solar panels operatively mounted to the main structure, configured to adopt:
a stowed position, in which the panels are substantially located within or adjacent to an extremity of said base and said inboard section; and,
an operative position, in which the panels are arranged in the form of an array of substantially upwardly facing panels.

16. A method of supplying portable power, including the steps of:
transporting the portable power generating apparatus, as claimed in any one of the preceding claims, whilst the apparatus is in the stowed position;
rearranging the position of the solar panels, from the stowed position to the operative position, such that the panels are arranged in the form of the array of substantially upwardly facing panels.

17. The portable power generating apparatus as claimed in claim 2, wherein each side frame is configured to move at least two panels which form said side group between;
a stowed position wherein said panels substantially overlap; and
an operative position wherein said panels are substantially side by side.

18. The portable power generating apparatus as claimed in claim 2, wherein each side frame includes a sliding track mechanism configured to effect sliding movement of at least two panels of said side group relative to each other.

19. The portable power generating apparatus as claimed in claim 2, wherein each side frame includes a hinge mechanism configured to effect pivotal movement of at least two panels of said side group relative to each other.

20. The portable power generating apparatus as claimed in claim 2, wherein said solar panels are configured to be angularly adjustable so as to orient the panels towards the sun.
